(19) United States
(12) Patent Application Publication
(10) Pub. No.: US 2006/0221452 A1
(43) Pub. Date: Oct. 5, 2006

(54) Anti-glare reflective and transmissive devices

(76) Inventor: Zhan Chen, Carrollton, TX (US)

Correspondence Address: FISH & RICHARDSON, PC, P.O. BOX 1022, MINNEAPOLIS, MN, 55440-1022, US

(21) Appl. No.: 11/373,579

(22) Filed: Mar. 10, 2006

Related U.S. Application Data
(60) Provisional application No. 60/667,306, filed on Mar. 31, 2005.

(51) Int. Cl. G02B 5/08

(52) U.S. Cl. 359/603; 359/266

(57) ABSTRACT

Devices that include a dichroic material sandwiched between first and second electrodes layers and exhibiting a high optical absorption when the first and second electrode layers are biased at a first electrical bias state and a low optical absorption when the first and second electrode layers are biased at a second, different electrical bias state. Such devices may be used to construct optically reflective devices such as anti-glare mirrors and optically transmissive devices such as eye glasses. The dichroic material may be selected to be operable to switch between the high optical absorption and the low optical absorption in less than 0.1 second.

This application claims the benefit of U.S. Provisional Application No. 60/667,306 entitled “Antiglare Mirror” and filed Mar. 31, 2005, the entire disclosure of which is incorporated herein by reference.

### BACKGROUND

This application relates to antiglare mirrors for various applications including sunglasses, rearview mirrors and side view mirrors for automobiles.

Many mirrors for automobiles include a glass substrate, a metal film coated on the substrate, a dielectric protection film formed on the metal film and exhibit a high optical reflectivity of different values depending on the specific requirements of the applications. As a result, drivers of the vehicles may be temporarily blinded by the reflection glare caused by the rear view or side view mirrors based on such a design when, e.g., the sun shines behind or by the head light of vehicles behind at night. Such reflection glare can cause discomfort to the drivers and may lead to dangerous driving conditions for the drivers.

To mitigate the reflection glare, various glare-reduced mirrors have been developed and marketed. Some designs can switch the reflection from a high reflectivity to a low reflectivity to reduce the reflection glare. Various liquid crystal materials have been used to produce the varying reflectivities. See, e.g., U.S. Pat. Nos. 3,614,210 and 4,696,548. Various liquid crystal-based mirrors, however, suffer certain limitations in manufacturing and have not been widely produced for commercial use. Electrochromic materials have been adapted into antiglare mirror assembles and put into commercial production. One example of antiglare mirrors using electrochromic materials is described in U.S. Pat. No. 6,023,364.

### SUMMARY

This application discloses, among others, devices that include a first electrode layer; a second electrode layer that is) optically transparent; a dichroic material sandwiched between the first and second electrodes layers and exhibiting a high optical absorption when the first and second electrode layers are biased at a first electrical bias state and a low optical absorption when the first and second electrode layers are biased at a second, different electrical bias state; and a control circuit coupled to the first and second electrode layers and operable to control electrical bias between the first and second electrode layers and thus optical absorption of the dichroic material. Such devices may be used to construct optically reflective devices such as anti-glare mirrors and optically transmissive devices such as eye glasses. The dichroic material may be selected to be operable to switch between the high optical absorption and the low optical absorption in less than 0.1 second.

In one implementation, an antiglare mirror is described to include a metal layer that is optically reflective; an optically transparent, electrically conductive layer; a dichroic material sandwiched between the metal layer and the conductive layer and exhibiting a high optical absorption when an additional electrical control is applied and a low optical absorption when the additional electrical control is not applied; and a control coupled to the metal layer the conductive layer and operable to apply the electrical control to the dichroic material. The dichroic material switches between the high optical absorption and the low optical absorption in less than 0.1 second.

In another implementation, an antiglare mirror is described to include a metal layer that is optically reflective an optically transparent, electrically conductive layer; a dichroic material sandwiched between the metal layer and the conductive layers and exhibiting a high optical absorption when there is or no external electrical control is applied and a low optical absorption when an electrical control voltage is applied or turn off; and a control coupled to the metal layer and the conductive layer and operable to apply the electrical control to the dichroic material. The dichroic material switches between the high optical absorption and the low optical absorption in less than 0.1 second.

In yet another implementation, an anti-glare mirror is described to include a first electrode layer that is at least partially transparent and a second electrode layer that is at least partially transparent; a dichroic material sandwiched between the first and second electrodes layers and exhibiting a high optical absorption when the first and second electrode layers are biased at a first electrical bias state and a low optical absorption when the first and second electrode layers are biased at a second, different electrical bias state; a control circuit coupled to the first and second electrode layers and operable to control electrical bias between the first and second electrode layers and thus optical absorption of the dichroic material; and a reflective layer positioned to receive light transmitted through the first and second electrodes and the dichroic material and reflect the received light back. The dichroic material may be selected to be operable to switch between the high optical absorption and the low optical absorption in less than 0.1 second.

These and other implementations are described in greater detail in the attached drawings, the detailed description and claims.

### BRIEF DESCRIPTION OF DRAWINGS

FIG. 1 shows one example of a sandwich structure for an anti-glare mirror using an electrically controllable dichroic mixture layer that changes optical absorption in response to an electrical voltage applied thereon.

### DETAILED DESCRIPTION

The present inventor recognizes that the light density recovering time in electrochromic materials tends to be long, e.g., more than several seconds. Such a slow response may potentially create dangerous conditions for the drivers due to the reflection glare. In addition, the dimmed mirrors with electrochromic materials can appear greenish due to the spectral responses of electrochromic materials in some anti-glare mirrors using electrochromic materials. The greenish tone of the reflected image is not natural and is not desirable. There is a need for anti-glare mirrors with a fast response time and natural-grey scale looking images.

This application describes, among others, implementations of antiglare mirrors using optical-absorbing materials with adjustable absorptions in response to electrical control signals. In one implementation, an antiglare mirror includes a dichroic or dichroic mixture material film which is sandwiched between a high reflecting metal surface and a transparent conducting front electrode. The dichroic or dichroic mixture material exhibits a low absorption when the light passes through in a direction perpendicular to the elongated molecular axis of the material, and a high absorption when the light propagates along the molecule's long axis direction. A lower absorption state can be switched to a high absorption state by applying an electric field or vice versa. A properly formulated dichroic or dichroic mixture material can operate at a relatively fast switching speed when changing between the high and low absorption states, e.g., less than 0.1 second. In addition, the absorption of such a material is not sensitive to wavelength and hence absorbs light substantially equally at the visible wavelengths. This broadband spectral absorption of the dichroic or dichroic mixture material produces a natural appearance in the dimmed reflection of the mirror. Various dichroic or dichroic mixture materials may be used. The mirrors with dichroic or dichroic mixture materials may be advantageously used as a rearview mirror or side mirrors which are capable of producing a fast response time, e.g., less than one tenth of a second, and producing natural grey scaled black-white view on both glare prevention and non-glare prevention states. If desired, a dichroic dye may be used to purposely create a desired colored tone in the reflection of the antiglare mirrors. Different dichroic dyes may be used to achieve different colored tones when the mirrors are dimmed.

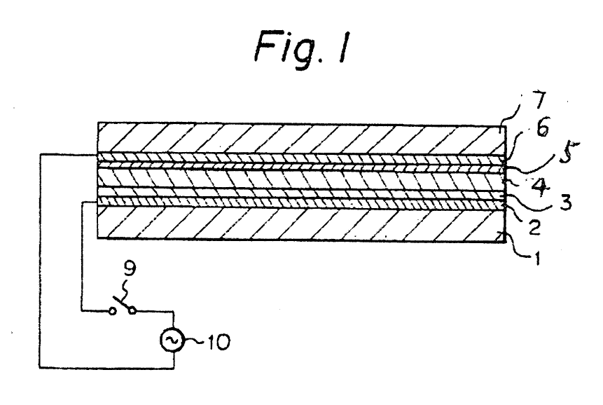

FIG. 1 shows an example of an antiglare mirror using a dichroic or dichroic mixture material. Layer 1 is a back substrate and may be made of an opaque or transparent material. The layer 2 is a metal coating layer as part of the electrical control mechanism of the mirror and may be partially or fully optically reflective. Layer 3 is a dielectric coating layer that interfaces with a dichroic mixture layer 4. The dichroic mixture layer 4 responds to a control electrical signal such as a control voltage to change its optical absorption and thus the degree of reflection of the mirror. Examples for suitable materials for the dichroic mixture layer 4 include dichroic dyes such as anthraquinone dyes. More specific examples are dichroic dyes AG1, AR1 and AB3 manufactured by Nematel of Germany. On the other side of the dichroic mixture layer 4, a second dielectric coating layer 5 is provided so that the layer 4 is sandwiched between two dielectric layers 3 and 5. A transparent electrode coating layer 6 such as ITO is used on top of the dielectric layer 6 as part of the part of the electrical control mechanism of the mirror. The electrical control signal is applied to the electrode coating layers 6 and 2 to control and change the voltage on the dichroic mixture layer 4. In addition, a front transparent substrate 7 such as a glass substrate is placed on top of the electrode layer 6. An electrical control circuit, which may include an electric switch 9 controlled by the incident light and a power source 10, is electrically connected to the electrodes 2 and 6 to supply the electrical control signal. The electric switch 9 may be implemented by various light-sensitive switches that use a photo sensor and the threshold light intensity that triggers the switching operation can be set by design based on the specific requirements in an application where the anti-glare mirror is used. One or more light detectors may be included as part of the switch 9 and are assembled behind the metal coating 2, for example, to measure incident light. The Power source 10 may be a 2˜11 V adjustable AC power source in some implementations.

In operation, light is incident to the mirror in FIG. 1 through the front transparent substrate 7, passes through the dichroic mixture layer 4 and is reflected back to pass through the dichroic mixture layer 4 for the second time. When the incident light received by the mirror reaches or exceeds the threshold light intensity of the light-sensitive switch 9, the AC power between metal layer 2 and front electrode 6 is switched on (or off for different dichroic materials) to operate the dichroic layer 4 at a high absorption state to reduce the reflection glare. Otherwise, the dichroic layer 4 is set to the low absorption state. The absorption in the dichroic layer 4 is adjusted and controlled by controlling the voltage. This adjustment can be used to provide different comfortable viewing conditions for different drivers.

The mirror in FIG. 1 may be further configured to include a display window made of LCD or LED to display various information such as turning signal, compass and temperature.

In implementations, the material for the dichroic layer 4 may be selected so that a low absorption state is achieved when no voltage is applied across the layer 4. Alternatively, the mirror in FIG. 1 may also use dichroic or dichroic mixture materials that exhibit a high optical absorption when the control voltage is off and a low optical absorption when the control voltage is on.

The sandwich structure for the anti-glare mirror in FIG. 1 may be modified for constructing anti-glare transmissive devices such as anti-glare eye glasses and sunglasses. In an anti-glare transmissive device, the back substrate 1 and the back electrode layer 2 are made transparent materials so light can transmit through the entire structure. This structure may be used in various applications and can be, e.g., a structure of sunglasses. A compact battery may be used as the power source 10 so that eye glasses and sunglasses using this design are light and compact.

In an alternative implementation, the metal layer 2 may be used as an optical reflective surface while an additional transparent electrode layer is placed between the metal layer 2 and the dichroic mixture layer 4 so that the dichroic mixture layer 4 is placed between the additional transparent electrode layer and the transparent electrode layer 6. The control voltage is then applied between the two transparent electrode layers.

In summary, only a few implementations are disclosed. However, it is understood that variations and enhancements may be made.

What is claimed is:

1. An antiglare mirror, comprising:
a first electrode layer;
a second electrode layer that is optically transparent;
a dichroic material sandwiched between the first and second electrodes layers and exhibiting a high optical absorption when the first and second electrode layers are biased at a first electrical bias state and a low optical absorption when the first and second electrode layers are biased at a second, different electrical bias state, wherein the dichroic material switches between the high optical absorption and the low optical absorption in less than 0.1 second; and
a control circuit coupled to the first and second electrode layers and operable to control electrical bias between the first and second electrode layers and thus optical absorption of the dichroic material.

2. The mirror as in claim 1, wherein the control circuit further comprises a sensor which causes the first electrical bias state to be applied when light received in the mirror is greater than a threshold intensity and causes the second electrical bias state to be applied when light received in the mirror is less than the threshold intensity.

3. The mirror as in claim 2, wherein the sensor comprises one or more light detectors which are assembled behind the metal coating to measure incident light.

4. The mirror as in claim 1, wherein the second electrode layer is made of ITO.

5. The mirror as in claim 4, further comprising an additional dielectric layer between the ITO layer and the dichroic material.

6. The mirror as in claim 1, wherein the dichroic material includes a dichroic liquid crystal mixture.

7. The mirror as in claim 1, wherein the dichroic material includes a dichroic dye.

8. The mirror as in claim 1, wherein the first electrode layer is at least partially optically reflective.

9. The mirror as in claim 1, wherein the first electrical bias state is a state where a voltage is applied to the dichroic material and the second electrical bias state is a state where no voltage is applied to the dichroic material.

10. The mirror as in claim 1, wherein the second electrical bias state is a state where a voltage is applied to the dichroic material and the first electrical bias state is a state where no voltage is applied to the dichroic material.

11. A pair of eye glasses, comprising:
a first electrode layer that is optically transparent;,
a second electrode layer that is optically transparent;
a dichroic material sandwiched between the first and second electrodes layers and exhibiting a high optical absorption when the first and second electrode layers are biased at a first electrical bias state and a low optical absorption when the first and second electrode layers are biased at a second, different electrical bias state; and
a control circuit coupled to the first and second electrode layers and operable to control electrical bias between the first and second electrode layers and thus optical absorption of the dichroic material.

12. The pair of eye glasses as in claim 11, wherein the control circuit further comprises a sensor which causes the first electrical bias state to be applied when light received in the mirror is greater than a threshold intensity and causes the second electrical bias state to be applied when light received in the mirror is less than the threshold intensity.

13. The pair of eye glasses as in claim 11, wherein the first and second electrode layers are made of ITO.

14. The pair of eye glasses as in claim 11, wherein the dichroic material includes a dichroic liquid crystal mixture.

15. The pair of eye glasses as in claim 11, wherein the dichroic material includes a dichroic dye.

16. The pair of eye glasses as in claim 11, wherein the first electrical bias state is a state where a voltage is applied to the dichroic material and the second electrical bias state is a state where no voltage is applied to the dichroic material.

17. The pair of eye glasses as in claim 11, wherein the dichroic material is operable to switch between the high optical absorption and the low optical absorption in less than 0.1 second.

18. An antiglare mirror, comprising:
a first electrode layer that is at least partially transparent and a second electrode layer that is at least partially transparent;
a dichroic material sandwiched between the first and second electrodes layers and exhibiting a high optical absorption when the first and second electrode layers are biased at a first electrical bias state and a low optical absorption when the first and second electrode layers are biased at a second, different electrical bias state;
a control circuit coupled to the first and second electrode layers and operable to control electrical bias between the first and second electrode layers and thus optical absorption of the dichroic material; and
a reflective layer positioned to receive light transmitted through the first and second electrodes and the dichroic material and reflect the received light back.

19. The mirror as in claim 18, wherein the dichroic material is operable to switch between the high optical absorption and the low optical absorption in less than 0.1 second.

20. The mirror as in claim 18, wherein the dichroic material includes a dichroic dye.
